(19) United States
(12) Patent Application Publication
(10) Pub. No.: US 2005/0274821 A1
(43) Pub. Date: Dec. 15, 2005

(54) Heated spray applicator

(75) Inventor: Jerome J. Sroka, St. Clair Shores, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/866,279

(22) Filed: Jun. 11, 2004

(51) Int. Cl. B05B 1/28

(52) U.S. Cl. 239/290

(57) ABSTRACT

A spray applicator for spraying polyurethane in a spray forming process is provided with a jacket that partially encloses a portion of the spray applicator and retains a heated gas that is supplied from a source of heated gas. The spray tool receives polyurethane forming components at one end that are dispensed into a nozzle at the opposite end. The gas heats the polyurethane mixture within the spray tool and is then emitted from the jacket to heat and shape the polyurethane spray. A method of spray forming an article with a reactant mixture is also disclosed. The method comprises heating a reactant mixture in a spray applicator as it sprays the mixture. The spray pattern is shaped by impingement of the heated gas on the reactant mixture as the heated gas is released from the jacket.

### BACKGROUND OF THE INVENTION

1. Field of the Invention

The present invention relates to a heated spray apparatus for a reactant mixture used to form an article.

2. Background Art

Spray applicators are used to apply paint and other fluids. Some spray applicators are adapted to spray multi-component reactant polymeric material mixtures for various purposes. For example, polyurethane skins may be formed in a spray-forming process to form vehicle interior parts. Polyurethane skins are formed and may be then foam backed and/or assembled to inserts to form finished interior parts.

To form satisfactory parts that meet vigorous inspection requirements, there is a need to apply the reactant mixture used to form the skin with a substantially even surface finish and uniform spray pattern. The uniformity of a sprayed part or skin is also impacted by the speed of the reaction rate and contour of the mold used to form the part. Uneven spray patterns tend to create irregularities in the shape or surface finish of a product made with the spray-forming process. Slow reaction rates for reactant mixtures can lead to unacceptable surface imperfections such as runs, “finger marks” and heavy deposits of material at the ends of a spray-forming stroke. Uneven mold surfaces, such as mold surfaces having undercuts or narrow portions can also result in thin areas and excessive accumulation of material in products formed by the spray forming process.

Reactant mixtures may also be adversely impacted by moisture, especially while the reactant mixture is undergoing its intended chemical reaction. For example, in the formation of polyurethane skins, moisture can cause bubbles which may become entrapped in the finished product creating surface imperfections.

In some polyurethane spray-forming operations, component material heaters may be provided to heat the components of the reactant mixture prior to mixing. After the reactant components are mixed, they are provided to a spray applicator that does not have a heat source. Cooling of the reactant mixture can cause poor atomization and inconsistent results if the temperature varies. The reactant mixture is typically sprayed on a heated mold to accelerate the reaction.

These and other problems are addressed by applicants' invention as summarized below.

### SUMMARY OF THE INVENTION

According to one aspect of the present invention, a spray applicator for spraying a polyurethane composition in a spray-forming process is provided. The spray applicator includes a spray tool and a jacket partially enclosing the tool that is provided with a heated gas. The spray tool comprises an elongated tubular member having at least one opening at a receiving end and at least one opening at a dispensing end. Polyurethane forming components are supplied to the receiving end of the tubular member and dispensed through the dispensing end. A nozzle tip is secured to the dispensing end for spraying polyurethane forming components as a polyurethane mixture. The jacket may partially enclose the elongated tubular member of the spray tool. A source of a heated gas provides heated gas to the jacket through a port. The heated gas is ported from the jacket through ports that are adjacent the nozzle tip to direct the heated gas to impinge upon the polyurethane mixture as it is sprayed.

According to other aspects of the invention, the jacket may be a tubular body having a first end that is disposed near the receiving end of the tubular member and a second end that is disposed near the dispensing end of the tubular member. A back end cap may be secured to the first end of the jacket and to the receiving end of the tubular member to form a seal with the tubular member. A front end cap may be secured to the second end of the jacket and the dispensing end of the tubular member to form a seal with the tubular member. The front end cap may have an annular nozzle that defines ports for dispensing the heated gas from the jacket. The inlet port through which heated gas is provided to the jacket may be a side port that receives heated gas from the source of heated gas through a conduit.

According to another aspect of the present invention, a heater for a spray applicator for a reactant mixture that is sprayed by the applicator through a nozzle having a nozzle tip is provided. The heater includes a jacket defining an enclosed space and an inlet through which heated gas is supplied and an outlet through which the heated gas is released after heating the reactant mixture in a cavity formed in the spray applicator. A heated gas dispensing port is provided in the jacket that directs the flow of heated gas around the nozzle tip that may modify the reactant mixture spray pattern after the reactant mixture is sprayed from the nozzle tip.

According to another aspect of the present invention, a method of spray forming an article with a reactant mixture is provided. The method includes supplying a multi-part reactant mixture to a spray applicator. Heating the reactant mixture to form a heated reactant mixture while in the spray applicator by supplying a heated gas to an enclosure that at least partially encloses the spray applicator. The heated reactant mixture is then dispensed from the spray applicator in a spray pattern. The spray pattern of the heated reactant mixture is shaped by directing the heated gas to impinge upon the heated reactant mixture as the heated gas is ported from the enclosure.

According to other aspects of the method of the present invention, the step of dispensing the heated reactant mixture may further comprise spraying the heated reactant mixture through a nozzle. The step of spraying the spray pattern may further comprise providing a plurality of ports in an annular ring disposed about the nozzle. Alternatively, or in addition to the plurality of ports, the step of shaping the spray pattern may comprise providing an annular opening between an annular ring and the nozzle. The method may be practiced using heated air, nitrogen, or carbon dioxide as the heated gas.

These and other aspects of the present invention will be better understood in view of the attached drawings and detailed description of the invention provided below.

### BRIEF DESCRIPTION OF THE DRAWINGS

FIG. 1 is a perspective view of a spray applicator made according to the present invention;

FIG. 2 is a partial cross-sectional, exploded, elevation view thereof;

FIG. 3 is an end elevation view of an annular ring used to direct heated gas as it exits a heated jacket; and

FIG. 4 is a end elevation view of a back end cap of the heated jacket.

### DETAILED DESCRIPTION OF THE PREFERRED EMBODIMENTS

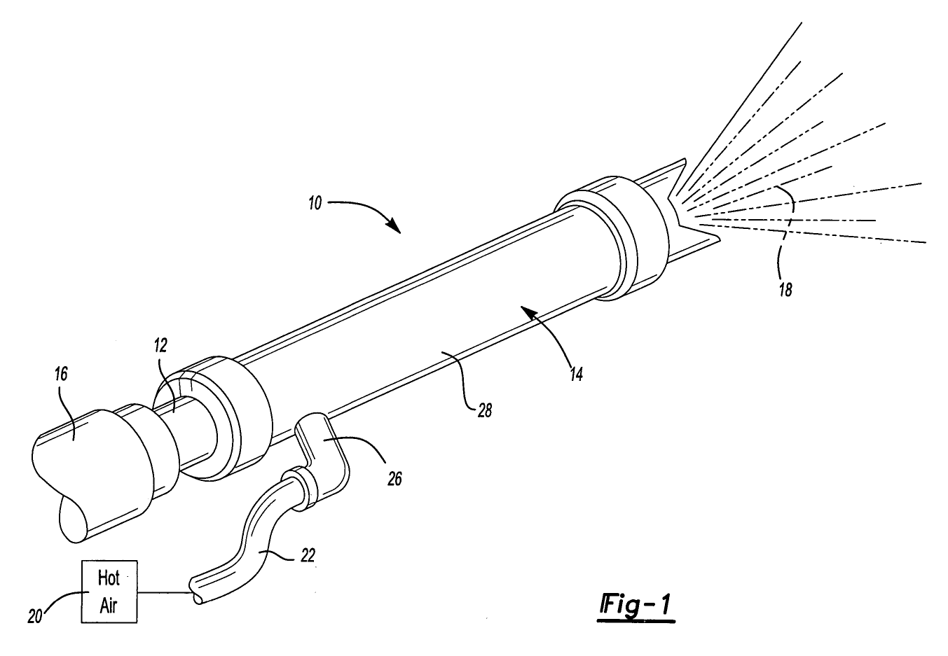

Referring to FIG. 1, spray applicator is generally indicated with reference numeral 10. The spray applicator 10 includes a spray tool 12 that is partially enclosed within the jacket 14. The spray tool 12 includes a mixhead 16 in which polyurethane forming components, polyol and isocyanate, are mixed. A polyurethane mixture 18 is dispensed from the applicator 10 in the form of a spray. A source of heated gas (i.e. air, nitrogen, or carbon dioxide) is connected to the jacket 14 by a conduit 22, such a hose or pipe. The heated gas is provided to the jacket 14 to heat the polyurethane mixture 18 as it passes through the portion of the spray tool 12 enclosed by the jacket 14. The heated gas may be discharged from the jacket to impinge upon the spray polyurethane mixture 18 to shape and dispense the polyurethane mixture 18 spray pattern. A fitting 26 is provided in a sidewall 28 of the jacket 14. The fitting receives the heated gas from the conduit 22 and supplies it to the jacket 14.

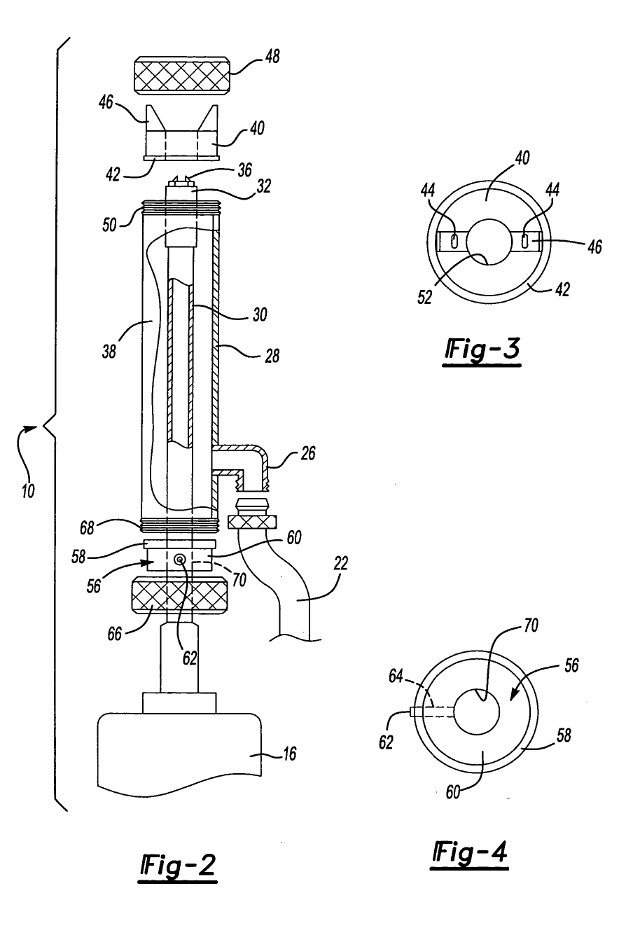

Referring to FIG. 2, the spray applicator 10 is described in greater detail. The spray tool 12 may have a static mixing tube 30 that terminates at its distal end in a nozzle 32. The nozzle 32 includes a spray tip 36 through which the polyurethane mixture 18 is dispensed in a predetermined spray pattern, for example, in a fan shape pattern.

The jacket 14 comprises a tubular body 38 that is provided with an annular nozzle 40. The annular nozzle 40 is also illustrated in FIG. 3. The annular nozzle 40 has a seat 42 that is assembled to one end of the tubular body 38. Air directing ports 44 are provided in the annular nozzle 40 that direct heated gas in generally the same direction as the polyurethane mixture 18 is sprayed from the spray tip 36. Projections 46 of the annular nozzle 40 define and orient the air directing ports 44. An attachment ring 48 is secured to a threaded end 50 of the tubular body 38. The annular nozzle 40 has a central bore 52 that is concentric with the spray tip 36. The attachment ring 48 holds the annular nozzle 40 on the tubular body 38 with the spray tip 36 being centered within the central bore 52.

While gas directing ports 44 may be used to direct the heated gas to impinge upon the polyurethane mixture 18 spray it is also possible that heated gas may be discharged from the jacket 14 through a gap defined between the spray tip 36 and central bore 52 of the annular nozzle 40. It is believed that hot gases flowing through the ports 44 may function to increase the width of the fan spray especially at high pressures while air flowing between the spray tip 36 and annular nozzle 40 may tend to decrease the width of the fan pattern of the polyurethane mixture 18.

The heated gas may be hot air that functions to shape the polyurethane mixture 18 spray and also may speed the reaction of the polyurethane mixture by both heating the polyurethane mixture in the static mixing tube 30. The heated gas may also speed the polyurethane curing reaction by heating the polyurethane mixture directly after it is emitted from the display tip 36. Alternatively, nitrogen may be used to perform a similar function and may also function to shield the polyurethane mixture 18 from ambient and that may include substantial humidity. As a third alternative it may be possible to inject steam as the heated gas into the jacket. The steam may be exhausted through the ports 44 or through other ports (not shown) that may direct the steam away from the polyurethane mixture spray.

A back end cap 56 is provided with a seat 58 and body portion 60. The seat 58 is assembled against the opposite end of the tubular body 38 from the annular nozzle 40. The body portion 60 is supported and centered by means of one or more set screws 62 relative to the tubular body 38. Each set screw 62 is received within a threaded hole 64 that holds the back end cap 56 in a concentric relationship relative to the tubular body 38. An attachment ring 66 is used to secure the back end cap 56 to the opposite end of the tubular body 38 from the annular nozzle 40. The attachment ring 66 is secured to a threaded end 68 of the tubular body 38. The tubular body 38 extends through a central bore 70 through the end cap 56.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A spray applicator for spraying a polyurethane composition in a spray-forming process, the spray applicator comprising:
a spray tool comprising an elongated tubular member having at least one opening at a receiving end and at least one opening at a dispensing end, wherein polyurethane forming components are supplied to the receiving end of the tubular member and dispensed through the dispensing end, the spray tool further comprising a nozzle tip secured to the dispensing end that is used to spray the polyurethane forming components as a polyurethane mixture;
a jacket partially enclosing the elongated tool member;
a source of a heated gas provides the heated gas to the jacket through a port and releases the heated gas from the jacket through ports that are adjacent the nozzle tip, the heated gas is directed in the same general direction as the polyurethane mixture is sprayed.

2. The spray applicator of claim 1 wherein the jacket is a tubular body having a first end that is disposed proximate the receiving end of the tubular member and a second end disposed proximate the dispensing end thereof.

3. The spray applicator of claim 2 further comprising a back end cap securing the first end of the jacket to the receiving end of the tubular member forming a seal with the tubular member and a front end cap securing the second end of the jacket to the dispensing end of the tubular member forming a seal with the tubular member.

4. The spray applicator of claim 3 wherein the front end cap further comprises an annular nozzle that defines the ports for dispensing the heated gas from the jacket.

5. The spray applicator of claim 1 further comprising an annular nozzle that defines the ports for dispensing the heated gas from the jacket.

6. The spray applicator of claim 1 wherein the port through which heated gas is provided to the jacket is a side port that receives heated gas from the source of heated gas through a conduit.

7. A heater for a spray applicator for a reactant mixture having at least two components that are mixed and provided to a cavity that terminates in a nozzle that sprays the liquid through a nozzle tip, the heater comprising:
a jacket defining an enclosed space having an inlet through which a heated gas is supplied for heating the reactant mixture in the cavity of the spray applicator; and
a heated gas dispensing port provided on the jacket that directs the heated gas to modify the reactant mixture spray pattern after the reactant mixture is sprayed from the nozzle tip.

8. The heater of claim 7 wherein the jacket is a tubular body having a first end that is disposed proximate the receiving end of the tubular member and a second end disposed proximate the dispensing end thereof.

9. The heater of claim 8 further comprising a back end cap securing the first end of the jacket to the receiving end of the tubular member forming a seal with the tubular member and a front end cap securing the second end of the jacket to the dispensing end of the tubular member forming a seal with the tubular member.

10. The heater of claim 9 wherein the front end cap further comprises an annular nozzle that defines the ports for dispensing the heated gas from the jacket.

11. The heater of claim 7 further comprising an annular nozzle that defines the ports for dispensing the heated gas from the jacket.

12. The heater of claim 7 wherein the inlet through which heated gas is provided to the jacket is a side port that receives heated gas from the source of heated gas through a conduit.

13. A method of spray forming an article with a reactant mixture, comprising:
supplying a multi-part reactant mixture to a spray applicator;
heating the reactant mixture to form a heated reactant mixture while in the spray applicator by supplying a heated gas to an enclosure that at least partially encloses the spray applicator;
dispensing the heated reactant mixture from the spray applicator in a spray pattern; and
shaping the spray pattern of the heated reactant mixture by directing the heated gas to impinge upon the heated reactant mixture as the heated gas is released from the enclosure.

14. The method of claim 13 wherein the step of dispensing the heated reactant mixture further comprises spraying the heated reactant mixture through a nozzle.

15. The method of claim 14 wherein the step of shaping the spray pattern further comprises providing a plurality of ports in an annular ring disposed about the nozzle.

16. The method of claim 14 wherein the step of shaping the spray pattern further comprises providing an annular opening between an annular ring and the nozzle.

17. The method of claim 13 wherein the heated gas is nitrogen.

18. The method of claim 13 wherein the heated gas is air.

19. The method of claim 13 wherein the heated gas is carbon dioxide.
